(19) United States
(12) Patent Application Publication
(10) Pub. No.: US 2026/0031972 A1
(43) Pub. Date: Jan. 29, 2026

(54) METHOD, APPARATUS, SYSTEM, AND COMPUTER PROGRAM FOR GENERATING VARIABLE-OUTPUT-LENGTH PSEUDO-RANDOM FUNCTION BASED ON BLOCK CIPHER

(71) Applicant: SAMSUNG SDS CO., LTD., Seoul (KR)

(72) Inventors: Byeonghak LEE, Seoul (KR); Seongkwang KIM, Seoul (KR)

(73) Assignee: SAMSUNG SDS CO., LTD., Seoul (KR)

(21) Appl. No.: 19/245,557

(22) Filed: Jun. 23, 2025

(30) Foreign Application Priority Data
Jul. 26, 2024 (KR) 10-2024-0099015
May 7, 2025 (KR) 10-2025-0059321

(51) Int. Cl. H04L 9/06; H04L 9/08

(52) U.S. Cl. CPC H04L 9/0618; H04L 9/0869

(57) ABSTRACT

The present disclosure relates to a block cipher-based variable-output-length pseudo-random number generation method, apparatus, system, and computer program, and more specifically, in the present disclosure, a method for generating a variable-output-length pseudo-random number using a computing device may include the steps of: generating a plurality of intermediate values, based on a given input value; producing a plurality of intermediate random values by performing block cipher-based encoding on the plurality of intermediate values; and deriving a final random value for the input value, based on a combination of the plurality of intermediate random values.

### CROSS-REFERENCE TO RELATED APPLICATION(S)

This application is based on and claims priority under 35 U.S.C. 119 to Korean Patent Application Nos. 10-2024-0099015, filed on Jul. 26, 2024, and 10-2025-0059321, filed on May 7, 2025 in the Korean Intellectual Property Office, the disclosures of which are herein incorporated by reference in its entirety.

### BACKGROUND OF THE INVENTION

### 1. Field of the Invention

The present disclosure relates to a block cipher-based variable-output-length pseudo-random number generation method, and an apparatus, system, and computer program based thereon and, more specifically, to a block cipher-based variable-output-length pseudo-random number generation method, apparatus, system, and computer program capable of generating a random number having a variable output length, based on a block cipher, and further providing high security and efficiency.

### 2. Description of the Prior Art

Recently, as various online services have been widely provided based on wired and wireless communication networks, the importance of security has been continuously increasing.

In this regard, a pseudo-random function (PRF) is one of the most fundamental technical elements in modern cryptography and is widely utilized in various cryptographic systems.

More specifically, a pseudo-random function (PRF) is a set of one or more functions that generate random numbers by emulating a random function, and may generate and output random numbers from given inputs such as a secret key and an input string, and in this case, it is difficult for any algorithm to distinguish between a function randomly selected from the set of pseudo-random functions and a true random function, so that the output of the pseudo-random function appears as a random string to an attacker who does not know the secret key.

In addition, the pseudo-random function (PRF) has the characteristic of operating based on a secret key while providing randomness widely required in cryptographic systems, and is widely used to implement various cryptographic protocols or cryptographic system elements such as symmetric encryption, message authentication codes (MAC), or the like.

Furthermore, a variable-output-length pseudo-random function (VOL-PRF) refers to a pseudo-random function that, unlike a general function (PRF) having a fixed output length, may generate outputs of various lengths specified by a user or the like.

Conventionally, the pseudo-random function (PRF) has been implemented based on a hash function or a block function, but a hash function-based pseudo-random function (PRF) is subject to a constraint in which its output length is fixed to the output length of the hash function.

In this regard, although it is possible to support a variable output length using an extendable output function (XOF), which is a variant of a hash function, even in such a case, there is a problem of lower efficiency compared to block ciphers and the like.

In addition, a block function-based pseudo-random function (PRF) may have reduced security because its security is generally limited to the level of n/2 bits when an n-bit block cipher is used.

In this regard, structures for improving security in n-bit block cipher-based pseudo-random functions (PRFs), such as Double-block-Hash-then-Sum style PRFs, Hash-then-modified-Benes-p2 (HtmB-p2), and XOR-of-Permutations (XORP), have been proposed, but such structures may suffer from low efficiency and limited applicability due to the fixed input or output length.

Accordingly, there has been a continued demand for a pseudo-random function (PRF) capable of efficiently generating a random number having a variable output length using a small amount of resources and having high security, but an appropriate solution for this has not yet been presented.

### SUMMARY OF THE INVENTION

The present disclosure has been made to solve the problems of the conventional technologies as described above and is to provide a block cipher-based variable-output-length pseudo-random number generation method, apparatus, system, and computer program capable of configuring a pseudo-random function (PRF) that efficiently generates a random number having a variable output length using a small amount of resources and has high security.

In addition, the present disclosure is to provide a block cipher-based variable-output-length pseudo-random number generation method, apparatus, system, and computer program capable of improving a cryptographic system by replacing a pseudo-random function (PRF) with low security in existing cryptographic systems, thereby ensuring high security while minimizing efficiency constraints.

The technical problems to be solved in the present disclosure are not limited to the technical problems mentioned above, and other technical problems not mentioned will be clearly understood by those skilled in the art to which the present disclosure pertains from the description in this specification.

In the first aspect of the present disclosure, a method for generating a variable-output-length pseudo-random number using a computing device may include the steps of generating a plurality of intermediate values, based on a given input value, producing a plurality of intermediate random values by performing block cipher-based encoding on the plurality of intermediate values, and deriving a final random value for the input value, based on a combination of the plurality of intermediate random values.

Here, the step of generating may include a step of receiving an input of a length s of the final random value and an encryption key of k bits along with the input value of 2n bits.

In addition, the step of generating may include the steps of calculating a number u of blocks corresponding to the final random value, based on a block having a length of n bits, and calculating a number v of intermediate values, based on u.

In addition, the step of generating may include a step of generating the v intermediate values, based on a first input value and a second input value obtained by dividing the input value in units of n bits.

In addition, the step of producing may include a step of producing v intermediate random values by performing block cipher-based encoding on the v intermediate values.

In this case, the step of deriving may include a step of deriving the u random value blocks, based on a combination of the v intermediate random values.

In addition, the step of deriving may include a final-random value deriving step of deriving a final-random value having the length s, based on the u random value blocks.

In addition, in the final-random value deriving step, the final random value may be derived by extracting bits of the length s from a random value obtained by concatenating the u random value blocks.

Furthermore, the step of generating may include a length pre-processing step of generating, for an unprocessed input value having an arbitrary length, the input value to have a predetermined length of 2n bits, based on a hash function.

In this case, the length pre-processing step may include a step of producing a first hash output value and a second hash output value by inputting the unprocessed input value and first and second hash keys, which are different from each other, into a first hash function configured to generate an n-bit output.

In addition, the length pre-processing step may include a step of producing a first hash random value and a second hash random value by performing block cipher-based encoding on the first hash output value and the second hash output value.

In addition, the length pre-processing step may include a step of generating the input value having a length of 2n bits by concatenating the first hash random value and the second hash random value.

In the second aspect of the present disclosure, an apparatus for generating a variable-output-length pseudo-random number may include a processor and a memory, wherein the memory may store instructions configured to cause, when executed by the processor, the apparatus to implement specific operations, and wherein the specific operations may include generating a plurality of intermediate values, based on a given input value, producing a plurality of intermediate random values by performing block cipher-based encoding on the plurality of intermediate values, and deriving a final random value for the input value, based on a combination of the plurality of intermediate random values.

In addition, in the third aspect of the present disclosure, a computer-readable storage medium may store instructions configured to cause, when executed by a processor, an apparatus, including the processor and generating a variable-output-length pseudo-random number, to implement specific operations, wherein the specific operations may include generating a plurality of intermediate values, based on a given value, producing a plurality of intermediate random values by performing block cipher-based encoding on the plurality of intermediate values, and deriving a final random value for the input value, based on a combination of the plurality of intermediate random values.

Accordingly, in a block cipher-based variable-output-length pseudo-random number generation method, apparatus, system, and computer program according to an embodiment of the present disclosure, it is possible to configure a pseudo-random function (PRF) that efficiently generates a random number having a variable output length using a small amount of resources and has high security.

In addition, in a block cipher-based variable-output-length pseudo-random number generation method, apparatus, system, and computer program according to an embodiment of the present disclosure, it is possible to improve a cryptographic system by replacing a pseudo-random function (PRF) with low security in existing cryptographic systems, thereby ensuring high security while minimizing efficiency constraints.

The effects obtainable from the present disclosure are not limited to the effects mentioned above, and other effects that are not mentioned will be clearly understood by those skilled in the art to which the present disclosure pertains from the description in this specification.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating the configuration of a pseudo-random number generation system according to an embodiment of the present disclosure;

FIG. 2 is a flowchart illustrating a pseudo-random number generation method according to an embodiment of the present disclosure;

FIG. 3 is a diagram illustrating a pseudo-random number generation apparatus according to an embodiment of the present disclosure;

FIG. 4 is a diagram illustrating a detailed flowchart of a generating step of a pseudo-random number generation method according to an embodiment of the present disclosure;

FIG. 5 is a diagram illustrating a detailed flowchart of a deriving step of a pseudo-random number generation method according to an embodiment of the present disclosure;

FIG. 6 is a diagram illustrating the efficiency of a pseudo-random number generation method according to an embodiment of the present disclosure;

FIG. 7 is a diagram illustrating a detailed flowchart of a length pre-processing step of a pseudo-random number generation method according to an embodiment of the present disclosure;

FIGS. 8 and 9 are diagrams illustrating a length pre-processing step of a pseudo-random number generation method according to an embodiment of the present disclosure; and

FIG. 10 is a diagram illustrating the configuration of an apparatus that performs pseudo-random number generation according to an embodiment of the present disclosure.

### DETAILED DESCRIPTION OF THE EXEMPLARY EMBODIMENTS

Hereinafter, the embodiments disclosed in this specification will be described in detail with reference to the attached drawings. The purpose, specific advantages, and novel features of the present disclosure will become more apparent from the following detailed description and preferred embodiments associated with the attached drawings.

Prior to the description, it should be understood that the terms or words used in the specification and the appended claims should not be construed as limiting the present disclosure, but interpreted as merely describing the embodiments, based on the meanings and concepts corresponding to technical aspects of the present disclosure, according to the principle that the inventor is allowed to define terms appropriately for the best explanation.

In assigning reference numerals to components, identical or similar components will be assigned the same reference numerals, regardless of the reference numerals, and redundant descriptions thereof will be omitted. The terms “module” and “unit” used for components in the following description are assigned or used interchangeably only in consideration of the ease of drafting the specification, and do not have distinct meanings or roles in themselves, which may indicate software or hardware components.

In describing the components of the present disclosure, singular expressions should be understood to encompass a plurality of components unless specifically stated otherwise. In addition, although the terms “first,” “second,” etc. are used to distinguish one component from another component, components are not limited to these terms. In addition, the case where a component is connected to another component may indicate that another component may be connected between the two components.

In addition, when describing the embodiments disclosed in this specification, a specific description of a related known technology, which may obscure the subject matter of the embodiments disclosed in this specification, will be omitted. In addition, the attached drawings are only intended to facilitate easy understanding of the embodiments disclosed in this specification, and the technical concepts disclosed in this specification are not limited to the attached drawings, and should be understood to encompass all modifications, equivalents, or substitutes included in the concepts 4 the present disclosure.

Next, exemplary embodiments of a block cipher-based variable-output-length pseudo-random number generation method, apparatus, system, and computer program according to the present disclosure will be described in detail with reference to the attached drawings.

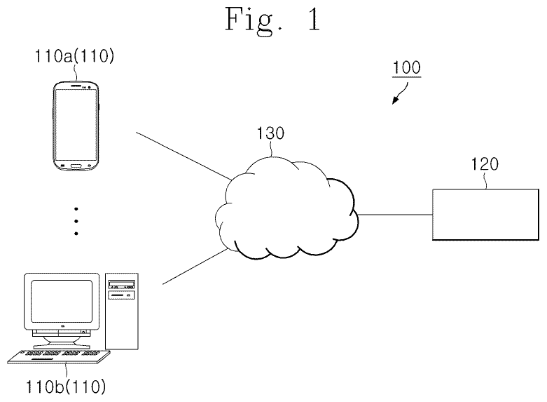

First, FIG. 1 illustrates the configuration and operation of a pseudo-random number generation system 100 according to an embodiment of the present disclosure. As shown in FIG. 1, the pseudo-random number generation system 100 according to an embodiment of the present disclosure may include one or more terminals 110 and a pseudo-random number generation apparatus 120 that is interlinked with the one or more terminals 110 and generates a pseudo-random number.

In this case, in the present disclosure, the terminal 110 may request the generation of a pseudo-random number from the pseudo-random number generation apparatus 120, provide input data necessary for generating the pseudo-random number, and further perform various functions such as providing services for cryptographic systems configured based thereon.

Here, although various terminals capable of participating in the pseudo-random number generation process, such as a personal computer (PC), a laptop PC, a tablet PC, a smartphone, and a PDA, may be used as the terminal 110, the present disclosure is not limited thereto, and various other devices may also be used as the terminal 110.

In addition, the pseudo-random number generation apparatus 120 may be an apparatus that generates a pseudo-random number while being interlinked with the terminal 110 or operating independently.

Here, the pseudo-random number generation apparatus 120 may be implemented using one or more physical server devices, but the present disclosure is not necessarily limited thereto, and in addition, it may be implemented in various forms configured as a network device such as a repeater, a hub, a bridge, a switch, a router, or a gateway, a home appliance such as a digital TV, or a personal terminal, or configured as a dedicated device.

Furthermore, the terminal 110 and the pseudo-random number generation apparatus 120 may be implemented in various forms, such as being configured by being combined into a single physical device.

In addition, a wired network and a wireless network may be used as a communication network 130 connecting the terminal 110 and the pseudo-random number generation apparatus 120 in FIG. 1, and specifically, various communication networks such as a local area network (LAN), a metropolitan area network (MAN), and a wide area network (WAN) may be included. In addition, the communication network 130 may include the well-known World Wide Web (WWW). In addition, the communication network 130 may be implemented using a data bus configured to transmit and receive data or the like.

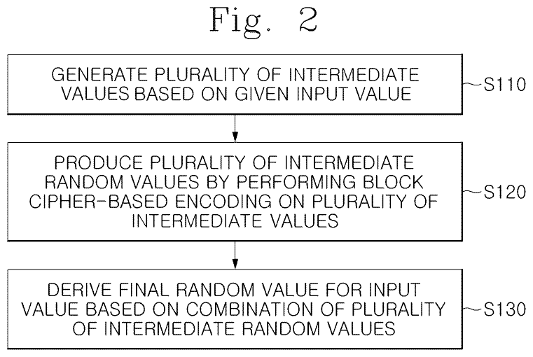

In addition, FIG. 2 illustrates a flowchart of a block cipher-based variable-output-length pseudo-random number generation method according to an embodiment of the present disclosure.

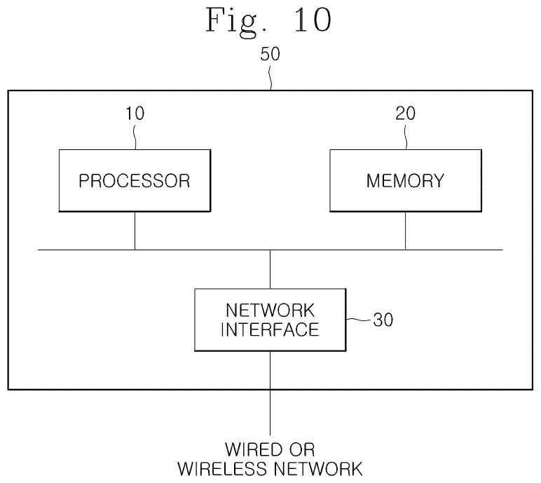

Here, the method illustrated in FIG. 2 may be performed by, for example, the pseudo-random number generation apparatus 120 in FIG. 1, and the pseudo-random number generation apparatus 120 may be implemented using a computing device 50 in FIG. 10 below and description with reference to FIG. 10. For example, the computing device 50 may have a processor 10, and the processor 10 may execute instructions configured to implement an operation for performing generation of a pseudo-random number.

More specifically, as shown in FIG. 2, a pseudo-random number generation method according to an embodiment of the present disclosure is a method of generating a variable-output-length pseudo-random number using a computing device 50, which may include a step S110 of generating a plurality of intermediate values based on a given input value, a step S120 of producing a plurality of intermediate random values by performing block cipher-based encoding on the plurality of intermediate values; and a step S130 of deriving a final random value for the input value, based on a combination of the plurality of intermediate random values.

Here, the generating step S110 may include a step S111 of receiving an input of a length s of the final random value and an encryption key of k bits along with the input value of 2n bits.

In addition, the generating step S110 may include a step S112 of calculating the number u of blocks corresponding to the final random value, based on a block having a length of n bits, and a step S113 of calculating the number v of the intermediate values, based on u.

In addition, the generating step S110 may include a step S114 of generating the v intermediate values, based on a first input value and a second input value obtained by dividing the input value in units of n bits.

In the producing step S120, v intermediate random values may be produced by performing block cipher-based encoding on the v intermediate values.

In this case, the deriving step S130 may include a step S131 of deriving u random value blocks, based on a combination of the v intermediate random values.

The deriving step S130 may include a final-random value deriving step S132 of deriving a final random value having the length s, based on the u random value blocks.

In addition, in the final-random value deriving step S132, the final random value may be derived by extracting bits of the length s from the random value obtained by concatenating the u random value blocks.

Furthermore, the generating step S110 may include a length pre-processing step S200 of generating the input value to have a predetermined length of 2n bits, based on a hash function, for an unprocessed input value having an arbitrary length.

In this case, the length pre-processing step S200 may include a step S210 of inputting a first hash key and a second hash key, which are different from each other, along with the unprocessed input value to a first hash function configured to generate an output of n bits, thereby producing a first hash output value and a second hash output value.

In addition, the length pre-processing step S200 may include a step S220 of producing a first hash random value and a second hash random value by performing block cipher-based encoding on the first hash output value and the second hash output value.

In addition, the length pre-processing step S200 may include a step S230 of generating the input value having a length of 2n bits by concatenating the first hash random value and the second hash random value.

Accordingly, in the block cipher-based variable-output-length pseudo-random number generation method, apparatus, system, and computer program according to an embodiment of the present disclosure, it is possible to configure a pseudo-random function (PRF) capable of efficiently generating a random number having a variable output length using a small amount of resources and having high security. Furthermore, it is possible to improve a cryptographic system by replacing a pseudo-random function (PRF) with low security in existing cryptographic systems, thereby ensuring high security while minimizing efficiency constraints.

Hereinafter, the configuration and operation of the block cipher-based variable-output-length pseudo-random number generation method, apparatus, and system according to an embodiment of the present disclosure will be described in more detail with reference to the drawings.

First, in the step S110, a computing device 50, such as the pseudo-random number generation apparatus 120, generates a plurality of intermediate values, based on a given input value.

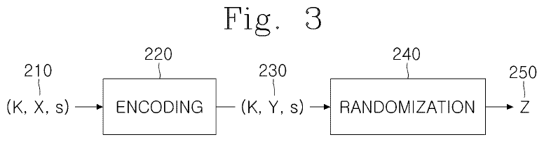

In this regard, FIG. 3 illustrates a specific configuration and operation of the pseudo-random number generation apparatus 120 according to an embodiment of the present disclosure.

Referring to FIG. 3, the pseudo-random number generation apparatus 120 may include an encoding unit 220 and a randomization unit 240, and in this case, the encoding unit 220 may generate a plurality of intermediate values Y, based on an input 210 including an encryption key K of a block cipher, an input value X for generating a pseudo-random number, and a length s of a final random value to be ultimately generated, and provide an output 230 including the encryption key K of the block cipher and the length s of the final random value to the randomization unit 240.

Subsequently, the randomization unit 240 may derive a final random value Z 250 having the length s through block cipher-based operations.

Here, a block cipher is an element technology for encrypting and decrypting information requiring confidentiality in units of blocks, and may be configured as, assuming that the key set is a set of k-bit strings and a block is an n-bit string, an encryption algorithm E:{0,1}^{k}×{0,1}ⁿ→{0,1}ⁿ and a decryption algorithm D:{0,1}^{k}×{0,1}ⁿ→{0,1}ⁿ, and may satisfy D(K,E(K,M))=M for any K∈{0,1}^{k} and M∈{0,1}ⁿ.

In this case, the block cipher must satisfy pseudo-random permutation security indicating that no efficient adversary is able to distinguish E(K,⋅) from an arbitrary permutation in {0,1}ⁿ for a random k-bit string K.

In addition, in the case where the key K is selected randomly from a key space [symbol] for a keyed function H: [symbol] × [symbol] → [symbol] and any distinct X,X′∈ [symbol] and any Y∈ [symbol] , if Pr[H (K,X)⊕H (K,X′)=Y]≤δ, H is called a δ-almost XOR universal (δ-AXU) hash function.

In addition, if H satisfies Pr[H(K,X)=Y]≤δ′ under the same conditions, H is called a o-almost uniform (S-AU) hash function.

Here, AU and AXU may be configured as polynomial-based hashes (Ghash or PolyHash) or block cipher-based hashes (PHash or CBC-Hash), which is more efficient than typical cryptographic hashes, and for example, may be configured as a simple polynomial operation such as PolyHash (K, X₁∥X₂∥ . . . ∥Xₘ)=K·X₁+K²·X₂+ . . . +K^{m}·Xₘ (where K, X₁, . . . , Xₘ are all elements of the Galois Field GF (2ⁿ).

Accordingly, the present disclosure may configure and provide a pseudo-random function (PRF) capable of efficiently generating a random number having an arbitrary output length s and providing high security.

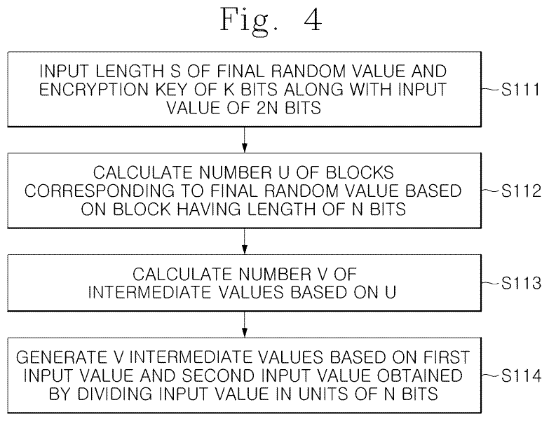

More specifically, FIG. 4 illustrates a detailed flowchart of the step S110.

In this case, as shown in FIG. 4, the step S110 may include a step S111 of receiving, along with an input value having a length of 2n bits, a length s of the final random value and an encryption key of k bits.

More specifically, referring to FIGS. 3 and 4, the pseudo-random number generation apparatus 120 may receive an input value X of 2n bits, a length s of the final random value, and an encryption key K of k bits for a block cipher.

For example, if the input value X is an 8-bit value such as “01101011,” then n is 4. If the final random value has a length of 10 bits, then s is 10. If the encryption key K used in the block cipher has 64 bits, then k is 64.

In addition, the step S110 may include a step S112 of calculating the number u of blocks corresponding to the final random value, based on a block having a length of n bits, and a step S113 of calculating the number v of intermediate values, based on u.

More specifically, in the step S112, since the final random value has a length of s bits and the block has a length of n bits, the number u of blocks corresponding to the final random value may be the smallest integer greater than or equal to s/n, as expressed in Equation 1 below.

$$u = ⌈ \frac{s}{n} ⌉ \qquad [ Equation 1 ]$$

For example, when s is 10 and n is 4, u may be 3.

Next, in the step S113, the number v of intermediate values may be calculated based on u, and in this case, v may represent the number of intermediate values required to derive u intermediate random values.

More specifically, as shown in Equation 2 below, v may be a value obtained by adding u to the smallest integer greater than or equal to u/w.

$$V = ⌈ \frac{u}{W} ⌉ + u \qquad [ Equation 2 ]$$

Here, w is a window parameter and may represent the number of blocks included in a group when the blocks are grouped.

For example, if u is 3 and w is 2, then v may be 5.

Next, in the step S114, the v intermediate values may be generated based on a first input value and a second input value obtained by dividing the input value in units of n bits.

In this case, since the input value X has a length of 2n bits, it may be divided into a first input value and a second input value in n-bit units.

For example, if the input value X is the 8-bit value “01101011,” the first input value A may be produced as “0110” and the second input value B may be produced as “1011.”

Here, the first input value A and the second input value B may be implemented by encoding them as elements of the Galois Field (GF), and in this case, GF (2ⁿ) is a finite field with 2ⁿ elements, and may be defined as GF(2)/F(W), where F(W) is an n-th order primitive polynomial. Hereinafter, a description will be made with W denoted as 2.

Subsequently, in the step S114, a intermediate value Yi may be generated for each i=1, . . . , and 5 (=v), and more specifically, five intermediate values Yi having a length of n bits may be derived based on Equation 3 below.

$${Y}_{i} = A ⊕ {2}^{i - 1} \cdot B \qquad [ Equation 3 ]$$

Here, ⊕ denotes bitwise XOR, and 2 may correspond to W described above.

Accordingly, as a more specific example, when the primitive polynomial F(W) of the Galois Field is W⁴+W³+1, the first input value A is “1110,” and the second input value B is “1011,” Y₁=A⊕B “1101” and Y₂=A⊕2·B=“0110”⊕(“1001”⊕“0110”)=“0110”⊕“1111”=“1001” may be obtained.

Then, the encoding unit 220 of the pseudo-random number generation apparatus 120 may group the intermediate values Yi into Y, as shown in Equation 4 below, and transmit the same along with the encryption key K of the block cipher and the length s of the final random value to the randomization unit 240.

$$Y = ( {Y}_{1} , … , {Y}_{v} ) \qquad [ Equation 4 ]$$

Next, in the step S120, the computing device 50, such as the pseudo-random number generation apparatus 120, performs block cipher-based encoding on the plurality of intermediate values to produce a plurality of intermediate random values.

Here, in the step S120, block cipher-based encoding may be performed on the v intermediate values to produce v intermediate random values.

More specifically, the randomization unit 240 of the pseudo-random number generation apparatus 120 may decode Y into n-bit blocks to produce the plurality of intermediate values Yi, and produce a plurality of intermediate random values Y′ᵢ by performing block cipher-based encoding on each i=1, . . . , and 5 (=v), as shown in Equation 5 below.

$${Y}_{i}^{′} = E ( K , {Y}_{i} ) \qquad [ Equation 5 ]$$

Here, E is a block cipher encoder, and E (K, M) denotes the result of encrypting an n-bit block M, based on a block cipher, using a k-bit encryption key K.

Next, in step S130, the computing device 50, such as the pseudo-random number generation apparatus 120, derives a final random value for the input value, based on a combination of the plurality of intermediate random values.

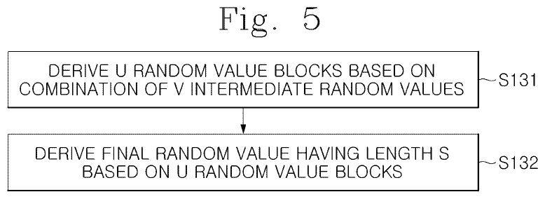

In this regard, FIG. 5 illustrates a detailed flowchart of the step S130.

In this case, as shown in FIG. 5, the step S130 may include a step S131 of deriving u random value blocks, based on a combination of the v intermediate random values.

More specifically, for each i=1, . . . , and 3 (=u), qᵢ may be the smallest integer greater than or equal to i/w, as expressed in Equation 6 below.

$${q}_{i} = ⌈ \frac{i}{w} ⌉ \qquad [ Equation 6 ]$$

In this case, in the step S130, u random value blocks Zi may be derived based on a combination of the five (=v) intermediate random values Y′ᵢ, as shown in Equation 7 below.

$${Z}_{i} = {Y}_{{q}_{i} \cdot ( w + 1 ) - w}^{′} ⊕ {Y}_{i + {q}_{i}}^{′} \qquad [ Equation 7 ]$$

Here,

$${Y}_{{q}_{i} \cdot ( w + 1 ) - w}^{′}$$

may be an intermediate random value corresponding to each group, and

$${Y}_{i + {q}_{i}}^{′}$$

may be an intermediate random value corresponding to each block. Accordingly, the random value block Zi may be derived by a combination of an intermediate random value corresponding to each group and an intermediate random value corresponding to each block.

In addition, the step S130 may include a final-random value deriving step S132 of deriving a final random value having the length s, based on the u random value blocks.

In this case, in the step S132, the final random value may be derived by extracting bits of the length s from a random value obtained by concatenating the u random value blocks.

More specifically, in the step S132, as shown in Equation 8 below, the final random value Z may be produced by extracting the length (s bits) given according to predetermined criteria, such as the first s bits, from a random value obtained by concatenating the u random value blocks Zi.

$$Z = first s - bit of {Z}_{1} ‖ … ‖ {Z}_{u} \qquad [ Equation 8 ]$$

Accordingly, in the block cipher-based variable-output-length pseudo-random number generation method according to an embodiment of the present disclosure, under the assumption that inputs are randomly selected, the probability that an attacker [symbol] who is limited to a total output length of σ blocks, a maximum output length of [symbol] blocks per call, and q calls successfully distinguishes the pseudo-random function (PRF) according to the present disclosure from a random function may range from ½ to

$$0 ( \frac{{σ}^{2} w ℓ}{{2}^{2 n}} + \frac{σ w}{{2}^{n}} ) .$$

According to the present disclosure may have n-bit-level security, assuming that the message length bound is a constant.

In addition, in the pseudo-random function (PRF) according to the present disclosure, w+1 block cipher operations are required to compute w output blocks. Since w may be set sufficiently large (e.g., 24) without difficulty, the increase in block cipher operation overhead is limited to approximately 5% (based on w=24) compared to the conventional CTR, so it is possible to ensure high security while minimizing the reduction in efficiency.

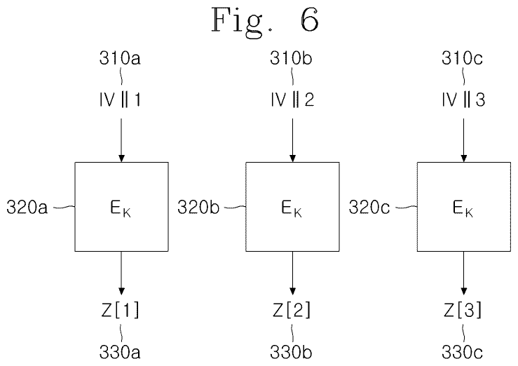

On the other hand, in the case of a block cipher-based pseudo-random function according to the conventional technique, as can seen in FIG. 6 illustrating be calculation of the first three blocks for a given input IV in the CTR mode, the block number is concatenated with the input IV and input to the block cipher so that one block cipher operation is performed for each block, which significantly increases block cipher operations and reduces efficiency.

Furthermore, in the block cipher-based variable-output-length pseudo-random number generation method according to an embodiment of the present disclosure, it is possible to extend the method so as to generate a variable-output-length pseudo-random number by receiving an input having an arbitrary length.

To this end, in the present disclosure, in the step S110, a length pre-processing step S200 of generating, for an unprocessed input value having an arbitrary length, the input value to have a predetermined length of 2n bits, based on a hash function, may be further performed.

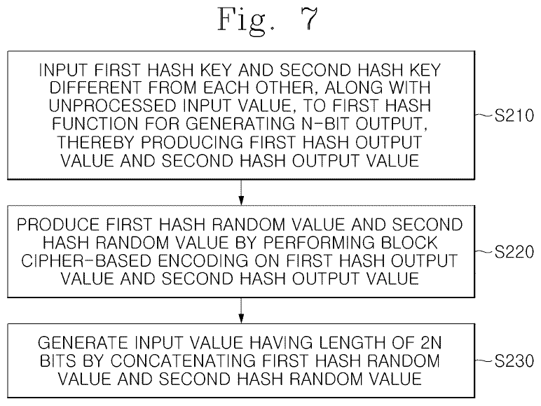

More specifically, FIG. 7 illustrates a detailed flowchart of the step S200.

In this case, as shown in FIG. 7, the step S200 may include a step S210 of producing a first hash output value and a second hash output value by inputting an unprocessed input value and first and second hash keys different from each other into a first hash function for generating an n-bit output.

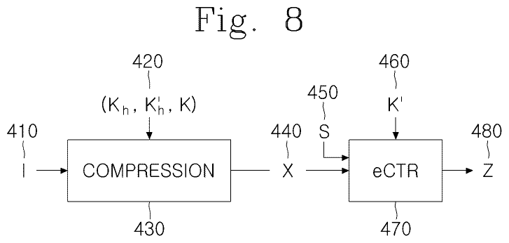

More specifically, referring to FIG. 8, a compression unit 430 of the pseudo-random number generation apparatus 120 may receive an unprocessed input value I 410 having an arbitrary length, and a block cipher key K of k bits and different first and second hash keys Kₕ and Kₕ′ 420.

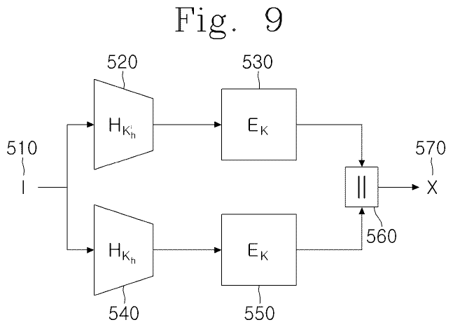

Accordingly, referring to FIG. 9, in the step S210, the unprocessed input value I 510 may be input into a hash function H 540 together with the first hash key Kₕ to produce a first n-bit hash output value, and it may be input into another hash function H 520 together with the second hash key Kₕ′ to produce a second n-bit hash output value.

As also shown in FIG. 7, the step S200 may include a step S220 of producing a first hash random value and a second hash random value by performing block cipher-based encoding on the first hash output value and the second hash output value.

More specifically, referring to FIG. 9, in the step S220, block cipher-based encoding may be performed (550) on the first hash output value to produce a first hash random value, and block cipher-based encoding may be performed (530) on the second hash output value to produce a second hash random value.

As further shown in FIG. 7, the step S200 may include a step S230 of generating the input value having a length of 2n bits by concatenating the first hash random value and the second hash random value.

More specifically, referring to FIG. 9, in the step S230, the first and second hash random values may be concatenated (560) to generate an input value X 570 having a length of 2n bits, and the input value X 570 having the length of 2n bits may be input into the encoding unit 220 of the pseudo-random number generation apparatus 120 and used to generate a pseudo-random number having a variable output length.

Accordingly, in the block cipher-based variable-output-length pseudo-random number generation method according to an embodiment of the present disclosure, under the assumption that the hash function H is δ-AU and δ-AXU, the probability that an attacker [symbol] who is limited to a total output length of σ blocks, a maximum output length of [symbol] blocks per call, and q calls successfully distinguishes the pseudo-random function (PRF) according to the present disclosure from a random function may range from ½ to

$$0 ( \frac{{σ}^{2} w ℓ}{{2}^{2 n}} + \frac{σ w}{{2}^{n}} + q δ + \frac{{σ}^{2} δ}{{2}^{n}} ) .$$

Accordingly, the pseudo-random function (PRF) according to the present disclosure may have n-bit-level security, assuming that the message length bound is a constant and

$$δ = 0 ( \frac{1}{{2}^{n}} ) .$$

In addition, since the computation of AU and AXU functions is generally more efficient than that of block ciphers, the efficiency of the pseudo-random function (PRF) according to the present disclosure is primarily influenced by the efficiency of the encoding unit 220 and the randomization unit 240. Therefore, the pseudo-random function according to the present disclosure may ensure high security while minimizing the reduction in efficiency.

Accordingly, the block cipher-based variable-output-length pseudo-random number generation method according to an embodiment of the present disclosure may configure a variable-output-length pseudo-random function (VOL-PRF) having high security and high efficiency, and have the following characteristics.
Support for arbitrary input and output lengths
Provision of n-bit-level security when based on an n-bit block cipher.
Achievement of efficiency comparable to that of conventional pseudo-random functions (PRFs)

Furthermore, in the block cipher-based variable-output-length pseudo-random number generation method according to an embodiment of the present disclosure, it is also possible to configure a highly secure and efficient cryptographic system based on a highly secure and efficient variable-output-length pseudo-random function (VOL-PRF). In this case, it is possible to replace the configuration of the pseudo-random function (PRF) in a conventional algorithm with the pseudo-random function (PRF) according to the present disclosure, thereby implementing an algorithm capable of providing high security while minimizing the reduction in efficiency.

As a more specific example, in conventional systems, when aiming for a 64-bit security level, data throughput quickly reaches its limit, so additional management such as key regeneration is required. However, in the block cipher-based variable-output-length pseudo-random number generation method according to an embodiment of the present disclosure, 128-bit-level security may be provided using the same block cipher, thereby improving usability.

In addition, in the block cipher-based variable-output-length pseudo-random number generation method according to an embodiment of the present disclosure, it is possible to improve efficiency by replacing the conventionally inefficient pseudo-random function (PRF) with the variable-output-length pseudo-random function (VOL-PRF) according to the present disclosure. As a more specific example, the variable-output-length pseudo-random function (VOL-PRF) according to the present disclosure provides efficiency that is not significantly lower than that of the conventional pseudo-random function (PRF) that provided 64-bit security based on a 128-bit block cipher. Therefore, it is possible to secure 128-bit-level security while maintaining efficiency comparable to cryptographic systems with 64-bit security.

More specifically, as a first practical application example of the present disclosure, length-preserving encryption may be illustrated.

Here, length-preserving encryption is a cryptographic system used when it is necessary to preserve the arbitrary length of data during encryption, such as disk encryption. HCTR [WFW05], which is usefully employed for this purpose, has a Hash-CTR-Hash structure, and the CTR, which is dual internal logic, may be replaced with the variable-output-length pseudo-random function (VOL-PRF) according to the present disclosure, thereby improving security without significantly sacrificing efficiency.

In addition, as a second practical application example of the present disclosure, an arbitrary nonce derived key may be illustrated.

Here, a pseudo-random function (PRF) may be used as a key derivation function (KDF) in itself. However, conventional key derivation functions (KDFs) have fixed input lengths limited to the key length, and are generally unable to accept input messages other than the typical 128-bit or 256-bit keys.

In this case, although the key derivation function (KDF) is still effective, it may cause a problem in which, when used in a nonce derived key used to enhance the security of authenticated encryption, the length of the nonce is restricted. When the variable-output-length pseudo-random function (VOL-PRF) according to the present disclosure is used in this case, such a problem may be resolved while attaining high security.

In addition, a computer program according to another aspect of the present disclosure may be a computer program stored on a computer-readable medium to execute a series of steps of the block cipher-based variable-output-length pseudo-random number generation method described above on a computer. The computer program may be not only a computer program including machine language codes created by a compiler, but also a computer program including high-level language codes executable in a computer using an interpreter or the like. In this case, the computer includes, in addition to a personal computer (PC) or a laptop computer, any type of information processing device equipped with a central processing unit (CPU) to execute a computer program, such as a server, a smartphone, a tablet PC, a PDA, or a mobile phone.

In addition, the computer-readable medium may be a medium that continuously stores a computer-executable program, or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Therefore, the above detailed description should not be construed as limiting the present disclosure in all respects and should be considered as examples. The scope of the present disclosure should be determined by a reasonable interpretation of the appended claims, and all changes within the equivalent scope of the present disclosure are included in the scope of the present disclosure.

In addition, a block cipher-based variable-output-length pseudo-random number generation apparatus according to an embodiment of the present disclosure may include a processor and a memory, and the memory may store instructions configured to cause, when executed by the processor, the apparatus to implement specific operations, and the specific operations may include: generating plurality of intermediate values, based on a given input value; producing a plurality of intermediate random values by performing block cipher-based encoding on the plurality of intermediate values; and deriving a final random value for the input value, based on a combination of the plurality of intermediate random values.

Here, the generating may include receiving an input of a length s of the final random value and an encryption key of k bits along with the input value of 2n bits.

In addition, the generating may include: generating a number u of blocks corresponding to the final random value, based on a block having a length of n bits; and generating a number v of intermediate values, based on u.

In addition, the generating may include generating the v intermediate values, based on a first input value and a second input value obtained by dividing the input value in units of n bits.

In addition, the producing may include producing v intermediate random values by performing block cipher-based encoding on the v intermediate values.

In this case, the deriving may include deriving the u random value blocks, based on a combination of the v intermediate random values.

In addition, the deriving may include deriving a final random value having the length s, based on the u random value blocks.

In addition, in the deriving of the final random value, the final random value may be derived by extracting bits of the length s from a random value obtained by concatenating the u random value blocks.

Further, the generating may include generating, for an unprocessed input value having an arbitrary length, the input value to have a predetermined length of 2n bits, based on a hash function.

In this case, the generating of the input value may include producing a first hash output value and a second hash output value by inputting the unprocessed input value and first and second hash keys, which are different from each other, into a first hash function configured to generate an n-bit output.

In addition, the generating of the input value may include producing a first hash random value and a second hash random value by performing block cipher-based encoding on the first hash output value and the second hash output value.

In addition, the generating of the input value may include generating the input value having a length of 2n bits by concatenating the first hash random value and the second hash random value.

In addition, FIG. 10 illustrates an example of an apparatus 50 to which the proposed method of the present disclosure may be applied.

Referring to FIG. 10, the apparatus 50 may be configured to implement a block cipher-based variable-output-length pseudo-random number generation process according to the proposed method of the present disclosure.

For example, the apparatus 50 to which the proposed method of the present disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as a digital TV and the like, and vehicles such as an automobile and the like. As another example, the apparatus 50 to which the present disclosure may be applied may be included as part of an ASIC (Application Specific Integrated Circuit) implemented in the form of an SoC (System-on-Chip).

The memory 20 may be connected to the processor 10 during operation, and may store programs and/or instructions for processing and controlling of the processor 10, and may store data and information used in the present disclosure, control information required for processing data and information according to the present disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM ((Electrically Erasable Programmable Read-Only Memory), a flash memory, an SRAM (Static RAM), an HDD (Hard Disk Drive), an SSD (Solid State Drive), and the like.

The processor 10 may be operatively connected to the memory 20 and/or a network interface 30, and may control the operation of respective modules in the apparatus 50. In particular, the processor 10 may perform various control functions for performing the proposed method of the present disclosure. The processor 10 may also be called a controller, a micro-controller, a micro-processor, a micro-computer, or the like. The proposed method of the present disclosure may be implemented by hardware, firmware, software, or a combination thereof. When implementing the present disclosure using hardware, an ASIC (application specific integrated circuit) or a DSP (digital signal processor), a DSPD (digital signal processing device), a PLD (programmable logic device), an FPGA (field programmable gate array), or the like, configured to perform the present disclosure, may be provided in the processor 10. Meanwhile, when implementing the proposed method of the present disclosure using firmware or software, the firmware or software may include instructions related to modules, procedures, or functions that perform functions or operations necessary for implementing the proposed method of the present disclosure, and the instructions may be stored in the memory 20 or stored in a computer-readable recording medium (not shown) separate from the memory 20, and may be configured to cause, when executed by the processor 10, the apparatus 50 to perform the proposed method of the present disclosure.

In addition, the apparatus 50 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE(-A), 3GPP 5G, etc., and may transmit and receive control information and/or data signals according to the corresponding communication standards. The network interface device 30 may be implemented outside the apparatus 50 as needed.

The embodiments described in this specification and the attached drawings are merely exemplary and do not limit the scope of the present disclosure in any way. In addition, the connections or connection members between the components illustrated in the drawings are examples of functional connections and/or physical or circuit connections, and may be represented as various functional connections, physical connections, or circuit connections that are replaceable or addible in an actual device. In addition, unless specifically stated with “essential,” “important,” etc., the components may not be essential for the application of the present disclosure.

In the specification (especially, in the claims) of the present disclosure, the term “said” and indicative terms similar thereto may be used for both a single element or multiple elements. In addition, if a range is stated in the present disclosure, it encompasses embodiments to which respective values within the range are applied (unless otherwise stated), and the respective values constituting the range are regarded as being described in the detailed description of the present disclosure. In addition, the steps presented in the method of the present disclosure are not intended to be restricted in their sequence, and the sequence thereof may be appropriately changed as needed, unless a certain step must precede according to the nature of the process. All examples or the use of exemplary terms (e.g., etc.) in the present disclosure is merely intended to describe the present disclosure in detail, and the scope of the present disclosure is not limited to the examples or exemplary terms, unless limited by the claims. In addition, those skilled in the art will understand that various modifications, combinations, and changes may be configured according to design conditions and elements without departing from the scope of the appended claims or their equivalents.

What is claimed is:

1. A method for generating a variable-output-length pseudo-random number using a computing device, the method comprising:
generating a plurality of intermediate values, based on a given input value;
producing a plurality of intermediate random values by performing block cipher-based encoding on the plurality of intermediate values; and
deriving a final random value for the input value, based on a combination of the plurality of intermediate random values.

2. The method of claim 1,
wherein the generating comprises
receiving an input of a length s of the final random value and an encryption key of k bits along with the input value of 2n bits.

3. The method of claim 2,
wherein the generating comprises:
calculating a number u of blocks corresponding to the final random value, based on a block having a length of n bits; and
calculating a number v of intermediate values, based on u.

4. The method of claim 3,
wherein the generating comprises
generating the v intermediate values, based on a first input value and a second input value obtained by dividing the input value in units of n bits.

5. The method of claim 3,
wherein the producing comprises
producing v intermediate random values by performing block cipher-based encoding on the v intermediate values.

6. The method of claim 5,
wherein the deriving comprises
deriving the u random value blocks, based on a combination of the v intermediate random values.

7. The method of claim 6,
wherein the deriving comprises
a final-random value deriving operation for deriving a final-random value having the length s, based on the u random value blocks.

8. The method of claim 7,
wherein, in the final-random value deriving operation,
the final random value is derived by extracting bits of the length S from a random value obtained by concatenating the u random value blocks.

9. The method of claim 1,
wherein the generating comprises
a length pre-processing operation for generating, for an unprocessed input value having an arbitrary length, the input value to have a predetermined length of 2n bits, based on a hash function.

10. The method of claim 1,
wherein the length pre-processing operation comprises
producing a first hash output value and a second hash output value by inputting the unprocessed input value and first and second hash keys, which are different from each other, into a first hash function configured to generate an n-bit output.

11. The method of claim 10,
wherein the length pre-processing operation comprises
producing a first hash random value and a second hash random value by performing block cipher-based encoding on the first hash output value and the second hash output value.

12. The method of claim 11,
wherein the length pre-processing operation comprises
generating the input value having a length of 2n bits by concatenating the first hash random value and the second hash random value.

13. An apparatus for generating a variable-output-length pseudo-random number, the apparatus comprising:
a processor; and
a memory,
wherein the memory stores instructions configured to cause, when executed by the processor, the apparatus to implement specific operations, and
wherein the specific operations comprise:
generating a plurality of intermediate values, based on a given input value;
producing a plurality of intermediate random values by performing block cipher-based encoding on the plurality of intermediate values; and
deriving a final random value for the input value, based on a combination of the plurality of intermediate random values.

14. A computer-readable storage medium storing instructions configured to cause, when executed by a processor, an apparatus, comprising the processor and generating a variable-output-length pseudo-random number, to implement specific operations, wherein the specific operations comprise:
generating a plurality of intermediate values, based on a given input value;
producing a plurality of intermediate random values by performing block cipher-based encoding on the plurality of intermediate values; and
deriving a final random value for the input value, based on a combination of the plurality of intermediate random values.
